(19) United States
(12) Patent Application Publication
(10) Pub. No.: US 2017/0019581 A1
(43) Pub. Date: Jan. 19, 2017

(54) ARRANGEMENT FOR, AND METHOD OF, REDUCING SERVER PROCESSING REQUIREMENTS OF A HOST SERVER

(71) Applicant: SYMBOL TECHNOLOGIES, LLC, LINCOLNSHIRE, IL (US)

(72) Inventors: RUSSELL E. CALVARESE, STONY BROOK, NY (US); CHARLES LAURIA, MILLER PLACE, NY (US)

(21) Appl. No.: 14/801,230

(22) Filed: Jul. 16, 2015

(51) Int. Cl. H04N 5/232; H04N 5/247

(52) U.S. Cl. CPC H04N 5/23206; H04N 5/247

(57) ABSTRACT

Video cameras are distributed throughout a venue. Each camera is operated under control of a host server to capture a video stream of images of targets at a frame rate and resolution. The server also controls radio frequency identification tag readers and item locationing devices in the venue. A level of utilization of a central processing unit and/or of a memory of the server is detected when the server is controlling the readers, locationing devices, and cameras. The frame rate and/or the resolution of one or more of the cameras are adjusted as a function of the detected level of utilization. The server performs at maximum performance in normal operation when few targets are captured by the cameras, and at less than maximum performance in a worst case condition when multiple targets are captured by the cameras, and gradually reduces its performance from normal operation to the worst case condition.

### BACKGROUND OF THE INVENTION

The present disclosure relates generally to an arrangement for, and a method of, reducing server processing requirements of a host server tasked with controlling multiple electronic devices, such as radio frequency (RF) identification (RFID) tag readers and item locationing devices, as well as a plurality of video cameras, all operating in a venue, such as a retail, factory, or warehouse environment, by managing the operation of the video cameras.

RFID systems are well known and are commonly utilized for product tracking, product identification, and inventory control in retail, factory, or warehouse environments. For example, in order to take an inventory of RFID-tagged products in a warehouse, it is known to position one or more RFID tag readers either overhead in a controlled area or inventory location, or at doorways, loading docks, and assembly lines, and then, to operate each such reader under the control of a host server to interrogate and read payloads of any tags that are in a coverage range of each reader.

It is also known to position item locationing devices in the controlled area to determine the location of mobile items, such as phones, radios, watches, tablets, or computers, present and movable within the controlled area. For example, one or more ultrasonic receivers can be operated under the control of the host server to determine the location of such mobile items that contain ultrasonic emitters. Each ultrasonic emitter transmits ultrasonic energy in a short burst which is received by an ultrasonic transducer (microphone) in each ultrasonic receiver, thereby establishing a presence of the mobile item within the controlled area, and providing a specific location of a particular mobile item in the controlled area using triangulation techniques known in the art.

It is still further known to position a plurality of video cameras distributed throughout the controlled area. Each video camera is operated under the control of the host server to capture a video stream of images of targets in its field of view. The targets can be the aforementioned RFID-tagged products and/or the mobile items, and can even be people, such as employees or customers, under surveillance by the cameras.

As previously mentioned, the host server is tasked not only with controlling all the RFID tag readers and processing a multitude of tags, all the item locationing devices and processing a multitude of mobile items, and all the video cameras and processing a multitude of video streams of the targets, but also with the essential tasks of running an operating system, maintaining all the networking protocols, and executing any loaded applications and program services. A substantial portion of the processing that is performed by a central processing unit (CPU) and a memory of the host server is the processing of the video streams from the multiple cameras. In a typical case or more frequent, normal operating condition, there are few or no targets located in one or more of the fields of view of the cameras, in which case the processing of the video streams by the host server is less intensive since there is little or no movement or activity in one or more of the video streams. In an infrequent, worst case condition, there are multiple targets located in each of the fields of view of the cameras, in which case the processing of the video streams by the host server is substantially more intensive since there are more targets and more motion and activity in the video streams. In a retail environment, the worst case condition occurs on busy shopping days, e.g., holiday sales.

The art has proposed that the CPU and the memory of the host server be configured to handle the infrequent, worst case condition without any performance degradation. This requires the CPU to have a higher processing capability and the memory to have a higher storage capacity, as compared to the processing capability and storage capacity needed for the typical case condition. This results in the host server being larger and more expensive due to the imposed requirement for extra server resources. In some cases, the host server may comprise more than one computer, thereby further increasing its size and expense. Yet, all this high processing capability and high storage capacity are normally not needed during the more frequent, typical case condition, thereby requiring the venue to accommodate the extra size, and wasting the extra cost, of the host server.

Accordingly, it would be desirable to configure the CPU and the memory of the host server to handle the frequent typical case condition, to gracefully trade server performance during the infrequent worst case condition, to decrease the number of computers that comprise the host server, and to reduce the size and expense of the host server.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic view of a host server tasked with controlling RFID tag readers, item locationing devices, and video cameras in a venue during a frequent, typical case condition in accordance with the arrangement of the present disclosure.

FIG. 2 is a view analogous to FIG. 1, but during an infrequent, worst case condition.

FIG. 3 is a view of a readout of a display connected to the host server of FIG. 1 during operation.

FIG. 4 is a flow chart depicting steps performed in accordance with the method of the present disclosure.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to an arrangement for reducing server processing requirements of a host server tasked with controlling multiple electronic devices, e.g., RFID tag readers and item locationing devices, as well as video cameras, in a venue, such as a retail, factory, or warehouse environment. Each video camera is configured to capture a video stream of images of targets in a field of view at a frame rate and a resolution. The arrangement includes a server manager module operated by the host server and configured to detect in real time a level of utilization of a central processing unit (CPU) and/or a memory of the host server when the host server is simultaneously controlling the electronic devices and the video cameras. The arrangement further includes a control module operated by the host server and configured to adjust the frame rate and/or the resolution of at least one, and preferably more, of the video cameras as a function of the detected level of utilization. More particularly, the control module reduces the frame rate and/or the resolution when the detected level of utilization exceeds a threshold level. The host server performs at maximum efficiency and performance in a typical case condition when a few of the targets are captured by the cameras, performs at less than maximum efficiency and performance in a worst case condition when a multitude of the targets is captured by the cameras, and gradually reduces its performance from the typical case condition to the worst case condition.

Another aspect of this disclosure is directed to a method of reducing server processing requirements of a host server tasked with controlling multiple electronic devices and video cameras in a venue, each video camera capturing a video stream of images of targets in a field of view at a frame rate and a resolution. The method is performed by detecting in real time a level of utilization of a central processing unit (CPU) and/or of a memory of the host server when the host server is simultaneously controlling the electronic devices and the video cameras, and by adjusting the frame rate and/or the resolution of at least one of the video cameras as a function of the detected level of utilization.

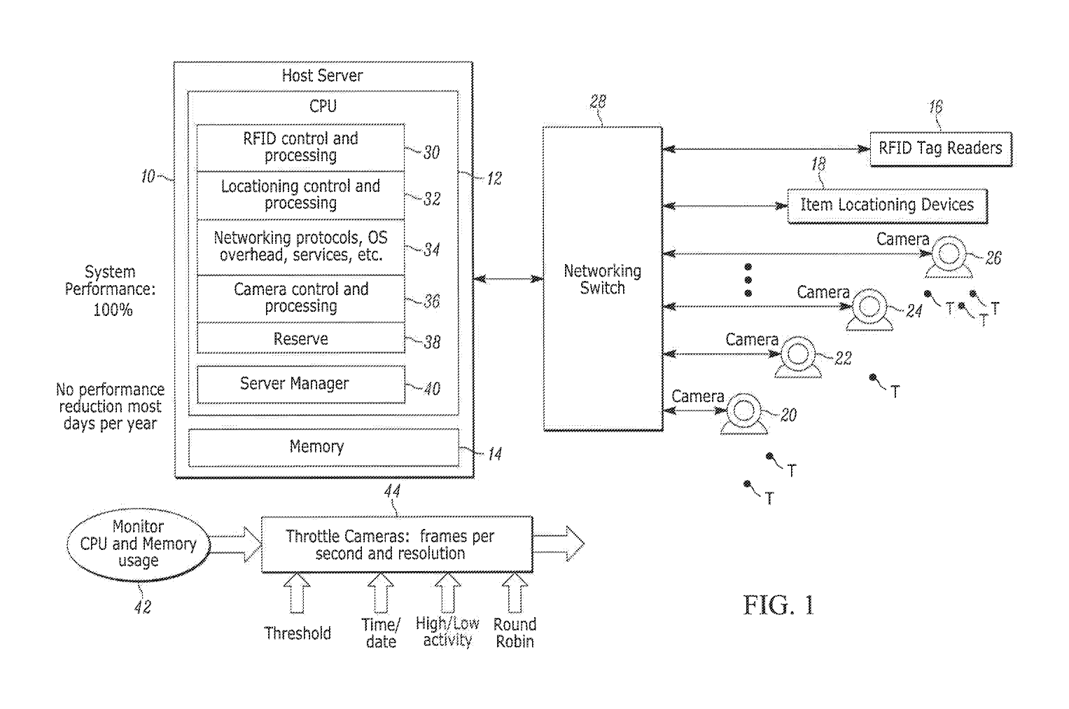

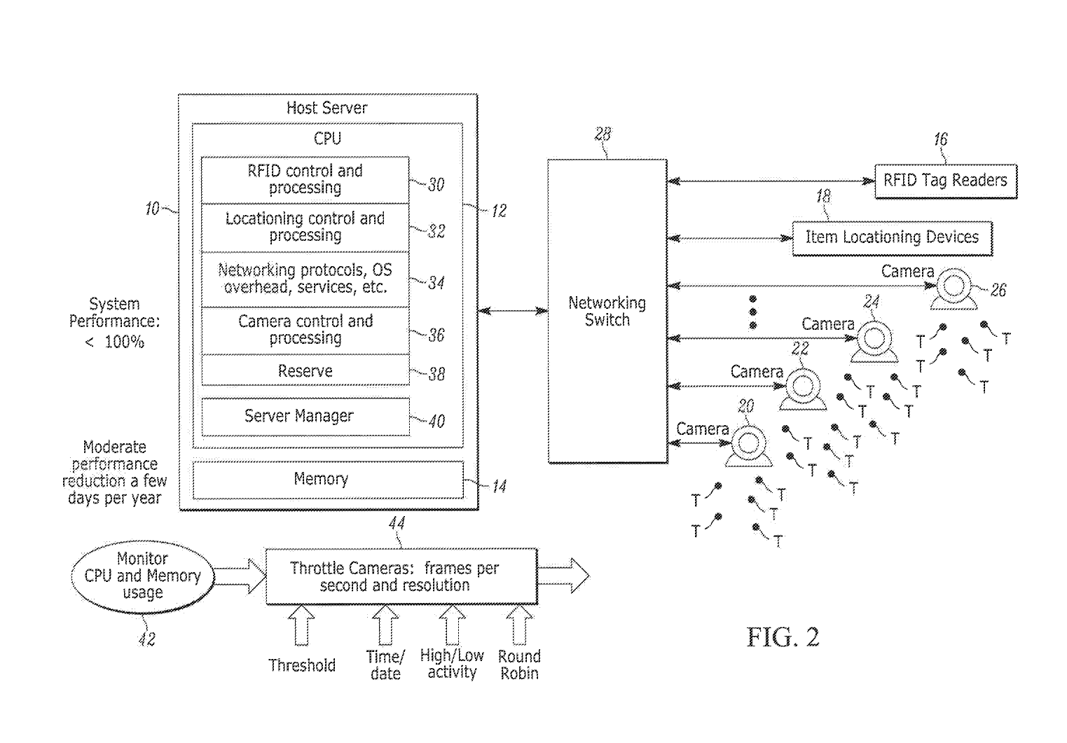

Turning now to the drawings, FIGS. 1-2 depict a programmed computer or host server 10 having a central processing unit (CPU) 12 and a memory 14. The host server 10 is tasked with controlling multiple electronic devices, such as radio frequency (RF) identification (RFID) tag readers 16 and item locationing devices 18, as well as a plurality of video cameras 20, 22, 24, 26, all operating in a venue, such as a retail, factory, or warehouse environment. One or more RFID tag readers 16 are positioned throughout the venue and are operatively connected to the host server 10 through a networking switch 28. An RFID control and processing module 30 in the CPU 12 operates each such tag reader 16 to interrogate and process the payloads of any RFID tags that are in a coverage range of each tag reader 16. It will be understood that there may be thousands of RFID tags in the venue.

One or more item locationing devices 18 are also positioned in the venue and are operatively connected to the host server 10 through the networking switch 28. A locationing control and processing module 32 in the CPU 12 operates each such item locationing device 18 to process and determine the location of items, such as mobile phones, radios, watches, tablets, or computers, present within the venue. For example, one or more ultrasonic receivers can be operated under the control of the host server 10 to process and determine the location of such mobile items that contain ultrasonic emitters. Each ultrasonic emitter transmits ultrasonic energy in a short burst which is received by an ultrasonic transducer (microphone) in each ultrasonic receiver, thereby establishing a presence of the mobile item within the venue, and providing a specific location of a particular mobile item in the venue using triangulation techniques known in the art. It will be understood that there may be hundreds of mobile items in the venue. Another module 34 in the CPU 12 performs the essential tasks of running an operating system, maintaining all the networking protocols, and executing any loaded applications and services.

The video cameras 20, 22, 24, 26, advantageously high-bandwidth, moving picture expert group (MPEG) compression cameras, are also positioned throughout the venue and are also operatively connected to the host server 10 through the networking switch 28. A camera control and processing module 36 in the CPU 12 operates each such video camera to capture a video stream of images of targets (T) in its field of view at a frame rate and a resolution. Preferably, the frame rate and/or the resolution are adjustable. The targets can be the aforementioned RFID-tagged products and the mobile items, and can even be people, such as employees or customers, under surveillance by the cameras. A typical frame rate can be adjusted anywhere from about eight to about thirty or more frames per second. A typical resolution can be adjusted anywhere from a video graphics array (VGA) resolution to a high definition (HD) graphics display resolution.

FIG. 1 depicts a typical or more frequent operating condition, in which there are few or no targets located in one or more of the fields of view of the cameras. In a retail environment, the typical operating condition occurs most days of each year. As illustrated in FIG. 1, camera 20 has two targets, camera 22 has no targets, camera 24 has one target, and camera 26 has three targets. FIG. 2 depicts an infrequent worst case condition, in which there is a multitude of targets located in each of the fields of view of the cameras. In a retail environment, the worst case condition occurs on busy shopping days, e.g., holiday sales. As illustrated in FIG. 2, each camera has five targets. It will be expressly understood that although only four cameras have been illustrated in FIGS. 1-2, a typical venue may have up to twenty, or forty, or eighty, or even more cameras depending on the size of the venue, and further that although only five targets have been illustrated the field of view of each camera in FIGS. 1-2, many more targets could be present. The processing burden on the camera control and processing module 36 is more intensive during the worst case condition since there are more targets and more motion and activity as compared to the typical condition.

In accordance with this disclosure, the CPU 12 and the memory 14 of the host server 10 are configured to handle the typical case condition with maximum (100%) performance (FIG. 1). An adequate resource reserve 38 is available in the CPU 12. This is in contrast to the known art, wherein the CPU 12 and the memory 14 of the host server 10 are instead configured to handle the worst case condition with no performance degradation. As described above, the known host server was larger and more expensive due to the imposed requirement for extra server resources, which were not needed most of the time. Also, the known host server had a very low reserve, which could result in a catastrophic failure if the reserve was exhausted.

Since a substantial portion of the processing that is performed by the CPU 12 and the memory 14 of the host server 10 is the processing of the video streams by the camera control and processing module 36, this disclosure proposes to manage the cameras in order to handle the worst case condition. Thus, a server manager module 40, also known as a performance monitor, in the CPU 12 is configured to monitor and detect in real time a level of utilization or usage of the CPU 12 and/or the memory 14 when the host server 10 is simultaneously controlling the RFID tag readers 16, the item locationing devices 18, and the video cameras 20, 22, 24, 26, and the camera control and processing module 36 is configured to adjust the frame rate and/or the resolution of at least one, and, if necessary, more or all, of the video cameras 20, 22, 24, 26 as a function of the detected level of utilization. The monitoring operation of the server manager module 40 is depicted in block 42 in FIGS. 1-2, and the adjusting operation of the camera control and processing module 36 (also known as throttling) is depicted in block 44 in FIGS. 1-2. Thus, in the worst case condition, some server performance is reduced by throttling the frame rate and/or the resolution of the cameras and is tolerated primarily due to its infrequent occurrence.

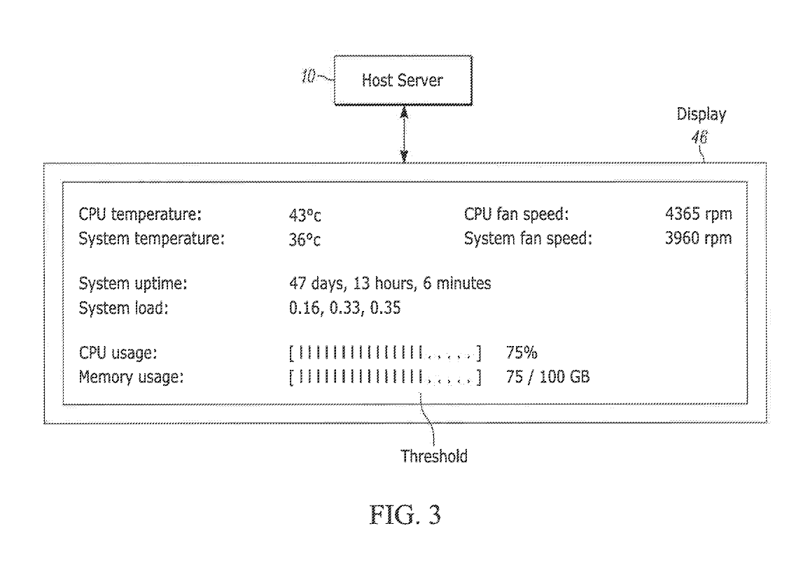

FIG. 3 depicts an exemplary readout of a display 46 that is connected to the host server 10 and, among other resources, shows the usage of the CPU 12 and the memory 14. A threshold level is depicted when the usage of the CPU 12 and/or the memory 14 is 75%. The camera control and processing module 36 reduces the frame rate and/or the resolution when the detected level of utilization exceeds the 75% threshold level. This reduces the processing burden on the host server 10, thereby handling the worst case condition with a reduced, but adequate, level of performance. It will be understood that the threshold level need not be 75%, but can be any value selected for a particular host server and a particular venue and, for example, can preferably be anywhere between 50% and 80%.

It is also contemplated that the camera control and processing module 36 can increase the frame rate and/or the resolution when the detected level of utilization is below another threshold level. For example, if the detected level of utilization is below, say a threshold level of about 25%, then the host server has adequate resources to handle the increased camera performance.

Each threshold level can be changed based on additional criteria (see block 44). For example, a threshold level can be changed based on the time of day, since more targets and more motion can be expected at certain hours than at other hours. Also, a threshold level can be changed based on the date, since more targets and more motion can be expected on certain calendar days than on other days. Also, a threshold level can be changed if a camera has captured little or no target activity. Also, a threshold level can be changed based on the location of a respective camera in the venue, since certain areas may be of less interest than other areas. Also, a threshold level can be changed based on a round-robin scheduling of the cameras.

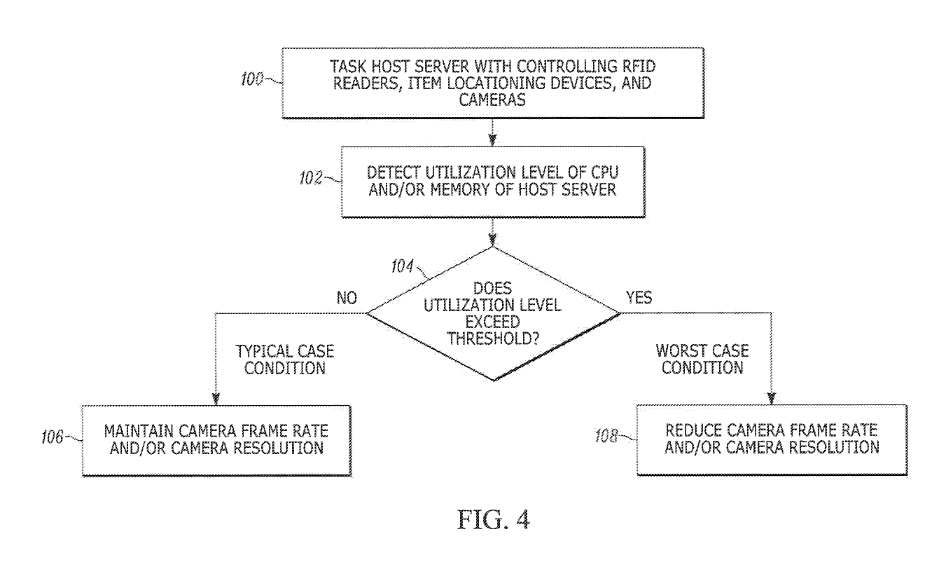

The disclosed method is performed, as shown in the flow chart of FIG. 4, by tasking the host server 10 with controlling the RFID tag readers 16, the item locationing devices 18, and the cameras 20, 22, 24, 26 (step 100), by the server manager 40 detecting the utilization level of the CPU 12 and/or the memory 14 of the host server 10 (step 102), and by the camera control and processing module 36 determining whether the detected utilization level exceeds a threshold (step 104). If not, then the camera control and processing module 36, which is operating in the typical case condition, maintains the camera frame rate and/or the camera resolution (step 106). If so, then the camera control and processing module 36, which is operating in the worst case condition, reduces the camera frame rate and/or the camera resolution (step 108). Thus, the host server 10 performs at maximum performance (100%) in the typical case condition when a few of the targets are captured by the cameras, and performs at less than maximum performance (<100%) in the worst case condition when a multitude of the targets is captured by the cameras. The host server 10 gradually and continuously reduces its performance from the typical case condition to the worst case condition.

In the foregoing specification, specific embodiments have been described. However, one of ordinary skill in the art appreciates that various modifications and changes can be made without departing from the scope of the invention as set forth in the claims below. Each above-described module is software running in the CPU 12, but can also be hardware-based. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An arrangement for reducing server processing requirements of a host server tasked with controlling multiple electronic devices and video cameras in a venue, each video camera being configured to capture a video stream of images of targets in a field of view at a frame rate and a resolution, the arrangement comprising:
a server manager module operated by the host server and configured to detect in real time a level of utilization of at least one of a central processing unit (CPU) of the host server and of a memory of the host server when the host server is simultaneously controlling the electronic devices and the video cameras; and
a control module operated by the host server and configured to adjust at least one of the frame rate and the resolution of at least one of the video cameras as a function of the detected level of utilization.

2. The arrangement of claim 1, wherein the control module is configured to reduce the at least one of the frame rate and the resolution when the detected level of utilization exceeds a threshold level.

3. The arrangement of claim 1, wherein the control module is configured to increase the at least one of the frame rate and the resolution when the detected level of utilization is below a threshold level.

4. The arrangement of claim 1, wherein the control module is configured to adjust the at least one of the frame rate and the resolution by comparing the detected level of utilization with a threshold level, and wherein the control module is configured to change the threshold level based on criteria selected from a group consisting of a time of day, a date, a number and activity of the targets in the field of view of a respective camera, a location of a respective camera in the venue, and a round-robin scheduling of the cameras.

5. The arrangement of claim 1, wherein the host server performs at maximum performance in a typical case condition when a few of the targets are captured by the cameras, wherein the host server performs at less than maximum performance in a worst case condition when a multitude of the targets is captured by the cameras, and wherein the host server gradually reduces its performance from the typical case condition to the worst case condition.

6. An arrangement for reducing server processing requirements of a host server tasked with controlling multiple radio frequency (RF) identification (RFID) tag readers, multiple item locationing devices, and multiple video cameras in a venue, each video camera being configured to capture a video stream of images of targets in a field of view at a frame rate and a resolution in a venue, the arrangement comprising:
a server manager module operated by the host server and configured to detect in real time a level of utilization of at least one of a central processing unit (CPU) of the host server and of a memory of the host server when the host server is simultaneously controlling the RFID tag readers, the item locationing devices, and the video cameras; and
a control module operated by the host server and configured to adjust at least one of the frame rate and the resolution of at least one of the video cameras as a function of the detected level of utilization.

7. The arrangement of claim 6, wherein the control module is configured to reduce the at least one of the frame rate and the resolution when the detected level of utilization exceeds a threshold level.

8. The arrangement of claim 6, wherein the control module is configured to increase the at least one of the frame rate and the resolution when the detected level of utilization is below a threshold level.

9. The arrangement of claim 6, wherein the control module is configured to adjust the at least one of the frame rate and the resolution by comparing the detected level of utilization with a threshold level, and wherein the control module is configured to change the threshold level based on criteria selected from a group consisting of a time of day, a date, a number and activity of the targets in the field of view of a respective camera, a location of a respective camera in the venue, and a round-robin scheduling of the cameras.

10. The arrangement of claim 6, wherein the host server performs at maximum performance in a typical case condition when a few of the targets are captured by the cameras, wherein the host server performs at less than maximum performance in a worst case condition when a multitude of the targets is captured by the cameras, and wherein the host server gradually reduces its performance from the typical case condition to the worst case condition.

11. A method of reducing server processing requirements of a host server tasked with controlling multiple electronic devices and video cameras in a venue, each video camera capturing a video stream of images of targets in a field of view at a frame rate and a resolution, the method comprising:
detecting in real time a level of utilization of at least one of a central processing unit (CPU) of the host server and of a memory of the host server when the host server is simultaneously controlling the electronic devices and the video cameras; and
adjusting at least one of the frame rate and the resolution of at least one of the video cameras as a function of the detected level of utilization.

12. The method of claim 11, wherein the adjusting is performed by reducing the at least one of the frame rate and the resolution when the detected level of utilization exceeds a threshold level.

13. The method of claim 11, wherein the adjusting is performed by increasing the at least one of the frame rate and the resolution when the detected level of utilization is below a threshold level.

14. The method of claim 11, wherein the adjusting is performed by comparing the detected level of utilization with a threshold level, and by changing the threshold level based on criteria selected from a group consisting of a time of day, a date, a number and activity of the targets in the field of view of a respective camera, a location of a respective camera in the venue, and a round-robin scheduling of the cameras.

15. The method of claim 11, and configuring the host server to perform at maximum performance in a typical case condition when a few of the targets are captured by the cameras, and at less than maximum performance in a worst case condition when a multitude of the targets is captured by the cameras, and gradually reducing the performance of the host server from the typical case condition to the worst case condition.
